(19) United States
(12) Patent Application Publication
(10) Pub. No.: US 2016/0159252 A1
(43) Pub. Date: Jun. 9, 2016

(54) APPARATUS FOR RECLINING REAR SEAT FOR VEHICLE

(71) Applicants: HYUNDAI MOTOR COMPANY, Seoul (KR); Kia Motors Corporation, Seoul (KR); DAE CHANG SEAT CO., LTD., Gyeongju-si (KR)

(72) Inventors: Chan Ho JEONG, Gunpo-si (KR); Sang Uk YU, Seoul (KR); Jung Sang YOU, Anyang-si (KR); Seon Chae NA, Yongin-si (KR); Myung Soo LEE, Ulsan (KR); In Chang HWANG, Ulsan (KR)

(21) Appl. No.: 14/667,558

(22) Filed: Mar. 24, 2015

(30) Foreign Application Priority Data
Dec. 8, 2014 (KR) 10-2014-0175241

(51) Int. Cl. B60N 2/10; B60N 2/22

(52) U.S. Cl. CPC B60N 2/10; B60N 2/22

(57) ABSTRACT

An apparatus for reclining a rear seat for a vehicle includes a cushion frame having a front end and a rear end, respectively, and rotatably mounted to a floor through a link. The cushion frame is connected to the floor via a motor driver to rotationally move forward as the motor driver operates. A back frame has a lower end rotatably mounted to the rear end of the cushion frame and an upper end having a connector connected to a vehicle body. A fastener is fixedly mounted to the vehicle body and adjacent to the upper end of the back frame. The fastener is rotatably connected to the connector.

### CROSS-REFERENCE(S) TO RELATED APPLICATIONS

The present application claims the benefit of priority to Korean Patent Application Number 10-2014-0175241 filed on Dec. 8, 2014, the entire contents of which application are incorporated herein for all purposes by this reference.

### TECHNICAL FIELD

The present disclosure relates to an apparatus for reclining a rear seat for a vehicle capable of reclining a seat as a seat cushion moves.

### BACKGROUND

A vehicle is provided with front seats on which a driver and a passenger sit and a rear seat for additional passengers in back of the front seats.

However, due to a spatial restriction, the existing rear seat of the vehicle is not provided with a reclining apparatus. As a result, passengers in the rear seat have to be seated in the same posture, as compared the driver or passenger in the front seat.

To solve the above problem, a rear seat disclosed in a related art has rear backs fixedly connected to both sides of a seat cushion of a rear seat and a reclining rear back including a recliner which is connected to the seat cushion between the rear backs. A seat cushion and a seat back according to the related art are recliners installed at left and right sides of the reclining rear back to rotate the reclining rear back with respect to the seat cushion forward and backward.

However, since only the seat back can be reclined and the seat cushion operating together with the seat back does not recline, comfort riding to rear seat passengers cannot be achieved only by controlling an angle of the seat back.

The contents described as the related art have been provided only for assisting in the understanding for the background of the present disclosure and should not be considered as corresponding to the related art known to those skilled in the art.

### SUMMARY

An aspect of the present inventive concept is directed to simultaneously performing reclining of a seat cushion and a seat back by changing an angle of the seat back which is operated together with the seat cushion at the time of the movement of the seat cushion.

Another aspect of the present inventive concept provides an apparatus for reclining a rear seat for a vehicle capable of providing more comfort riding quality to rear seat passengers.

Other objects and advantages of the present invention can be understood by the following description, and become apparent with reference to the embodiments of the present inventive concept. Also, it is obvious to those skilled in the art to which the present disclosure pertains that the objects and advantages of the present inventive concept can be realized by the means as claimed and combinations thereof.

In accordance with an embodiment of the present inventive concept, an apparatus for reclining a rear seat for a vehicle includes a cushion frame having a front end and a rear end, respectively, rotatably mounted to a vehicle floor through a link. The cushion frame is connected to the vehicle floor via a motor driver to rotationally move forward when the motor driver operates. A back frame has a lower end rotatably mounted to a rear end of the cushion frame and an upper end having a connector connected to a vehicle body. A fastener is fixedly mounted to the vehicle body and adjacent to the upper end of the back frame. The fastener is rotatably connected to the connector.

The front end is rotatably mounted to the vehicle floor through a first link and the rear end is rotatably mounted to the floor through a second link. The cushion frame rotationally moves forward by rotation of the first link and the second link at the time of the operation of the motor driver.

The motor driver may include a driving motor mounted to the front end of the cushion frame and a lead screw extending backward from the driving motor toward the rear end of the cushion frame to be connected to the floor. As the driving motor moves along the lead screw at the time of the operation of the driving motor, the cushion frame may rotationally move.

The rear end of the cushion frame and the lower end of the back frame may be connected to each other by a linkage to rotate to each other.

The linkage may include a first connection link rotatably installed at the rear end of the cushion frame and a second connection link rotatably connected to the first connection link and having a bracket to which the back frame is connected.

The connector may be a striker which extends downward from the upper end of the back frame and the fastener may be a fixed hook having a “U” shape of which the upper portion is opened and the connector may be inserted into the upper portion of the fastener.

When the connector extends downward from the upper end of the back frame into the upper portion of the fastener at a predetermined angle with respect to the back frame to be inclined, the connector may be kept at a right angle with respect to vehicle floor in the fastener.

The fastener may have a lower end fixed to a vehicle body and a front end and a rear end extending upward from a front portion and a rear portion of the lower end, respectively, and thus a fastening hole may be formed between the front end and the rear end.

The rear end of the fastener may have a flat upper portion extending backward and may be concavely recessed forward from a lower portion thereof and convexly protrude backward to be connected to the lower end of the fastener.

### BRIEF DESCRIPTION OF THE DRAWINGS

FIG. 1 is a perspective view of an apparatus for reclining a rear seat reclining for a vehicle according to an exemplary embodiment of the present inventive concept.

FIGS. 2 and 3 are diagrams illustrating an operation of an apparatus for reclining a rear seat for a vehicle illustrated in FIG. 1.

FIGS. 4 and 5 are diagrams illustrating a linkage of the apparatus for reclining a rear seat for a vehicle illustrated in FIG. 1.

FIGS. 6 and 7 are diagrams for describing an operation state of the apparatus for reclining a rear seat for a vehicle illustrated in FIG. 1.

FIG. 8 is a diagram illustrating a connector and a fastener of the apparatus for reclining a rear seat for a vehicle illustrated in FIG. 1.

### DETAILED DESCRIPTION

Hereinafter, an apparatus for reclining a rear seat for a vehicle according to an exemplary embodiment of the present inventive concept will be described with reference to the accompanying drawings.

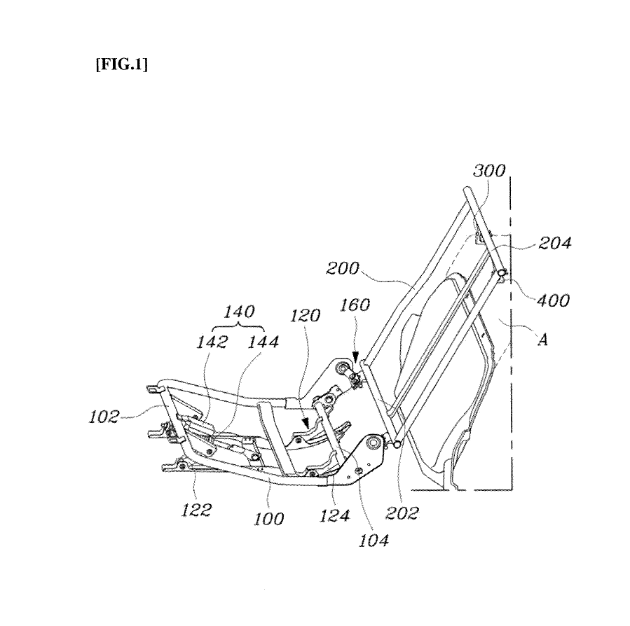

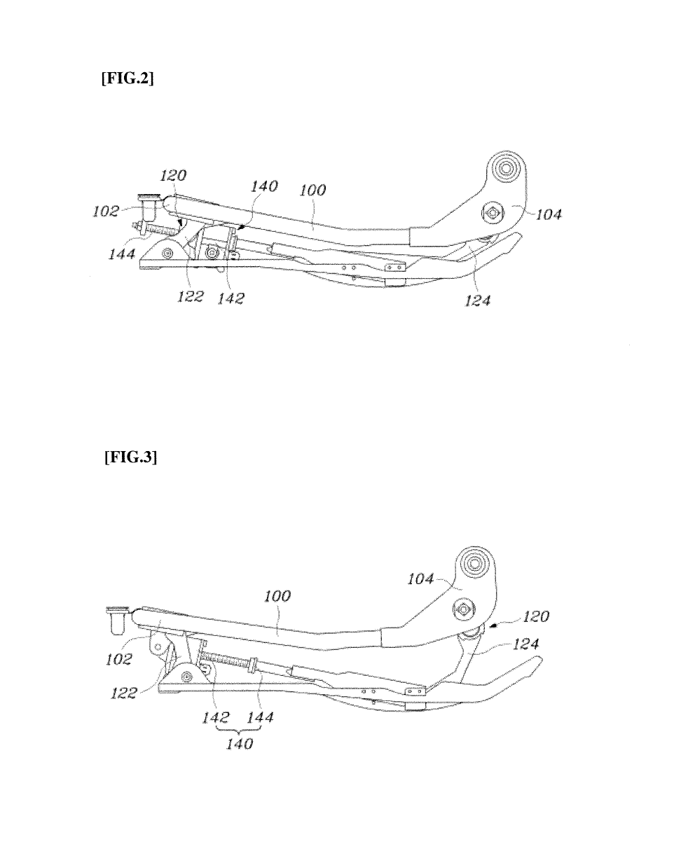

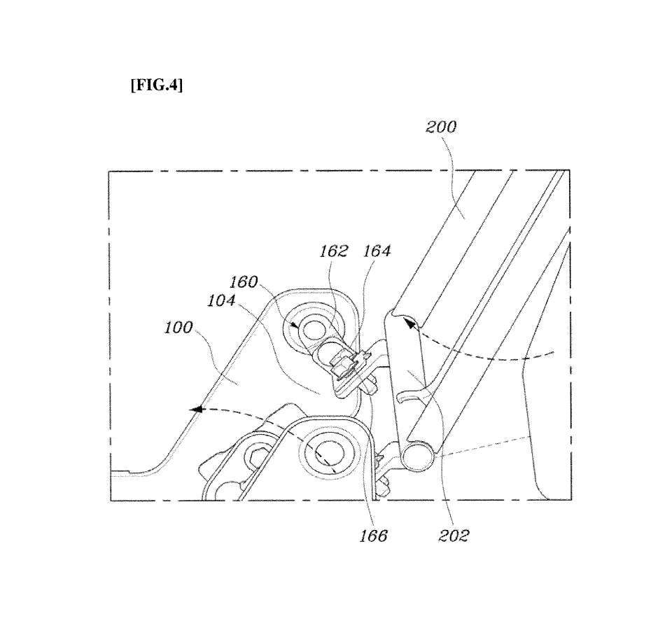

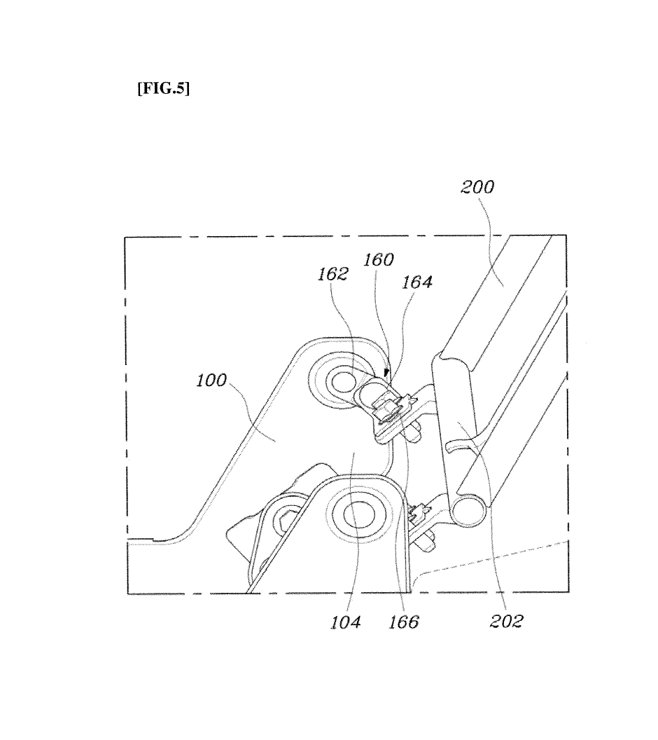

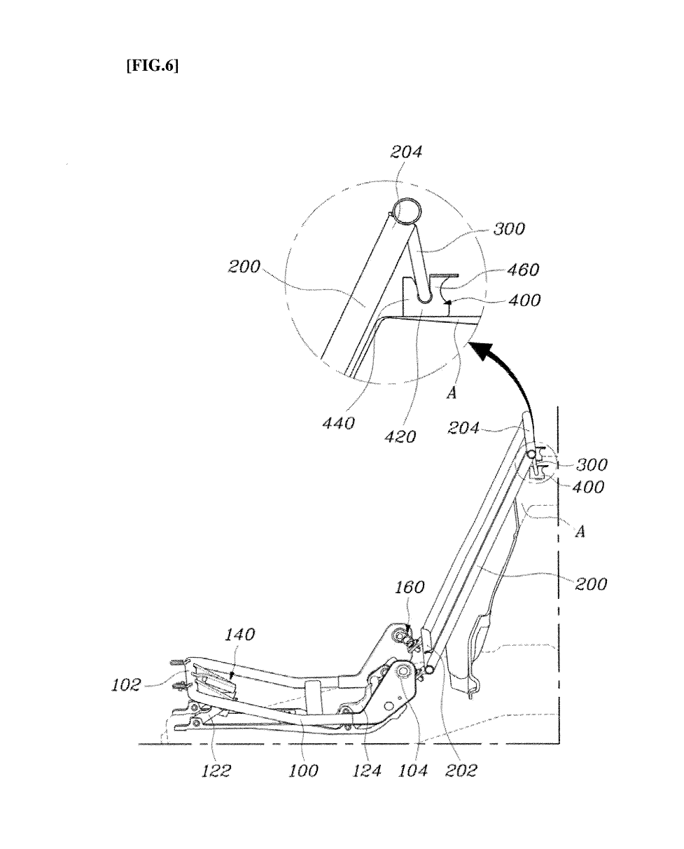

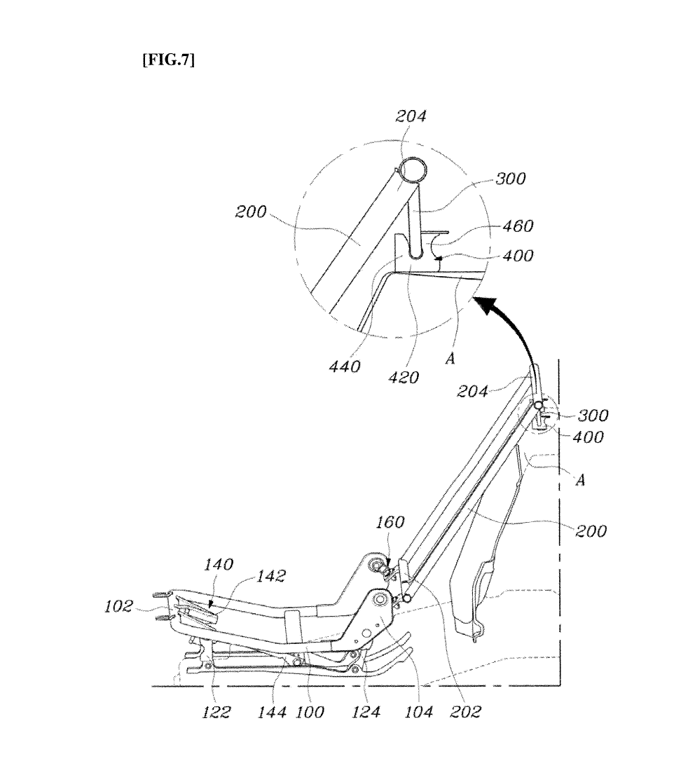

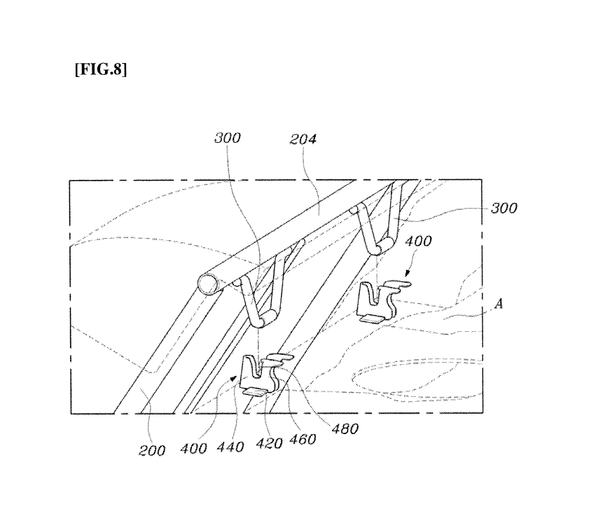

FIG. 1 is a perspective view of an apparatus for reclining a rear seat reclining for a vehicle according to an exemplary embodiment of the present inventive concept. FIGS. 2 and 3 are diagrams illustrating an operation of an apparatus for reclining a rear seat for a vehicle illustrated in FIG. 1. FIGS. 4 and 5 are diagrams illustrating a linkage of the apparatus for reclining a rear seat for a vehicle illustrated in FIG. 1. FIGS. 6 and 7 are diagrams for describing an operation state of the apparatus for reclining a rear seat for a vehicle illustrated in FIG. 1. FIG. 8 is a diagram illustrating a connector and a fastener of the apparatus for reclining a rear seat for a vehicle illustrated in FIG. 1.

As illustrated in FIG. 1, the apparatus for reclining a rear seat for a vehicle includes a cushion frame 100 having a front end 102 and a rear end 104 each rotatably installed at a vehicle floor through a link 120 and connected to the floor through a motor driver 140 to rotationally move forward at the time of an operation of the motor driver 140. A back frame 200 includes a lower end 202 rotatably connected to the rear end 104 of the cushion frame 100 and an upper end 204 provided with a connector 300 connected to a vehicle body A. A fastener 400, which is fixedly installed at the vehicle body A, is adjacent to the upper end 204 of the back frame 200 and rotatably connected to the connector 300.

That is, the cushion frame 100 and the back frame 200 are rotatably connected to each other, and the cushion frame 100 is connected to the floor through the link 120, such that when the cushion frame 100 rotates, the cushion frame 100 and the back frame 200 connected to the cushion frame 100 may simultaneously rotationally move.

In particular, the upper end 204 of the back frame 200 is provided with the connector 300 and the connector 300 is connected to the fastener 400 which is fixedly installed to the vehicle body A, such that when the back frame 200 rotates as the cushion frame 100 rotationally moves, an angle of the back frame 200 varies based on a point where the connector 300 is connected to the fastener 400 as a central point of rotation.

Referring to FIGS. 2 and 3, the cushion frame 100 has the front end 102 which is rotatably installed at the floor through a first link 122. The rear end 104 of the cushion frame 100 is rotatably installed at the floor through a second link 124 and may rotationally move forward by rotating the first link 122 and the second link 124 at the time of the operation of the motor driver 140.

As such, the front end 102 and the rear end 104 of the cushion frame 100 each are rotationally connected to one end of the first link 122 and one end of the second link 124, respectively, and another end of each of the front end 102 and the rear end 104 is rotatably connected to the floor, such that the cushion frame 100 may rotationally move forward and backward.

That is, the first link 122 and the second link 124 rotationally move while supporting a load of the cushion frame 100, and since the cushion frame 100 rotationally moves, the link 120 may be formed in plural to more secure the load.

Further, the link 120 may be directly installed at the floor but may be installed at the floor through a separate bracket, in which the bracket is installed at the floor or a moving rail installed at the floor, to slide the cushion frame 100 forward and backward.

The motor driver 140 includes a driving motor 142 which is installed at the front end 102 of the cushion frame 100 and a lead screw 144 which extends toward a rear of the driving motor 142 to be connected to the floor, such that at the time of the operation of the driving motor 142, the driving motor 142 may move along the lead screw 144, and thus, the cushion frame 100 may rotationally move.

As illustrated in FIG. 2, the driving motor 142 is fixedly installed at the front end 102 of the cushion frame 100, and the lead screw 144 which extends toward the rear of the driving motor 142 is fixedly installed at the floor. When the driving motor 142 of the motor driver 140 rotates, the driving motor 142 moves along a thread of the lead screw 144, such that the cushion frame 100 rotates by the link 120 connected to the cushion frame 100 while moving forward together with the driving motor 142.

The driving motor 142 may be operated depending on a user operation by a control of a separate controller, and may perform a reverse rotation to rotate the cushion frame 100 forward and backward.

As illustrated in FIGS. 4 and 5, the rear end 104 of the cushion frame 100 and the lower end 202 of the back frame 200 are connected to each other to rotate by a linkage 160.

The linkage 160 may include a first connection link 162 which is rotatably installed at the rear end 104 of the cushion frame 100 and a second connection link 164 which is rotatably connected to the first connection link 162 and is provided with a bracket 166 to which the back frame 200 is connected.

The rear end 104 of the cushion frame 100 and the lower end 202 of the back frame 200 may be rotatably connected to each other without the linkage 160. However, as illustrated in FIG. 4, a radius of rotation of the cushion frame 100 and that of the back frame 200 are different from each other, and a height of the rear end 104 of the cushion frame 100 and a height of the lower end 202 of the back frame 200 are different from each other at the time of the operation. Thus, the angle of the back frame 200 may smoothly vary by the connection of the linkage 160 which includes the first connection link 162 and the second connection link 164 as the cushion frame 100 rotates.

That is, as the cushion frame 100 rotationally moves forward at the time of the operation of the motor driver 140 and the upper end 204 of the back frame is fixed to the vehicle body A, as illustrated in FIG. 4, a connection point between the first connection link 162 and the second connection link 164 is bent downward at the time of the initial rotation of the cushion frame 100.

As illustrated in FIG. 5, when the rotation of the cushion frame 100 is completed, the connection point between the first connection link 162 and the second connection link 164 is bent upward, and thus even though the height of the rear end 104 of the cushion frame 100 and the height of the lower end 202 of the back frame 200 are changed, the cushion frame 100 and the back frame 200 may smoothly rotate.

Further, the second connection link 164 of the linkage 160 has the bracket 166, and the back frame 200 is bolted to the bracket, thereby simplifying installation.

Referring to FIG. 8, the connector 300 is a striker extending downward from the upper end 204 of the back frame 200, and the fastener 400 is a fixed hook having a U-letter shape of which the upper portion is opened. The connector 300 may be inserted into the fastener 400 from a top of the fastener 400 to a bottom thereof.

As such, since the striker which is the connector 300 is inserted into the fastener 400, which is the fixed hook having the U-letter shape, from the top to the bottom thereof, the back frame 200 may be simply installed in the vehicle body A. Further, as the connector 300 may be inserted into the fastener 400 and rotate, the back frame 200, which rotates with the cushion frame 100, smoothly changes the angle of the back frame 200 based on the point where the connector 300 is connected to the fastener 400 as the rotation central point.

In particular, the connector 300 extends downward from the upper end 204 of the back frame 200 toward a lower side at a predetermined angle as the rotation of the back frame 200 completes. When the connector 300 is maintained at a right angle with respect to the fastener 400 as the cushion frame 100 rotates, the height of the back frame 200 changes, and as the back frame 200 rotates backward, a seat back may recline backward.

The fastener 400 may have a lower end 420 fixed to the vehicle body A, and a front end 440 and a rear end 460 extending upward from a front portion and a rear portion of the lower end 420, respectively, and thus a fastening hole 480 may be formed between the front end 440 and the rear end 460.

That is, the lower end 420 may be fixed to the vehicle body A by bolting, and the front end 440 and the rear end 460 may extend upward from the lower end 420, thus forming the fastening hole 480, such that the connector 300 which is the striker may be inserted into the fastening hole 480. Here, an upper width of the fastening hole 480, which is formed by the front end 440 and the lower end 420, is smaller than a width of the connector 300, and a lower width thereof is equal to or large than the width of the connector 300, such that it is possible to prevent the connector 300 inserted into the fastening hole 480 from easily separating. Further, the fastener 400 is elastically deformable, and thus, the connector 300 is smoothly inserted when the connector 300 is inserted into the fastening hole 480 of the fastener 400, thereby improving convenience of an operation process.

The rear end 460 of the fastener 400, which extends backward making an a flat upper portion thereof, is concavely recessed toward a front from a lower portion thereof, and extends to convexly protrude toward a back, and thus connected to the lower end 420.

As such, the rear end 460 of the fastener 400 is formed to be bent and thus when the connector 300 is separated from the fastening hole 480 of the fastener 400, a portion where the rear end 460 is flat is pressed and thus the width of the fastening hole 480 is widened and then the separation of the connector 300 may be easily performed.

An operation of the apparatus for reclining a rear seat for a vehicle according to an exemplary embodiment of the present invention will be described below.

As illustrated in FIGS. 6 and 7, as the driving motor 142 rotates at the time of the operation of the motor driver 140, the driving motor 142 moves along the lead screw 144 and the cushion frame 100 to which the driving motor 142 is connected rotationally moves forward at the floor by the link 120.

As such, as the cushion frame 100 rotationally moves, the first connection link 162 and the second connection link 164 of the linkage 160 rotate and thus the rotation operation of the back frame 200 is performed.

As the connector 300 of the upper end 204 is connected to the fastener 400 at the time of the rotation operation of the back frame 200, the rotation operation of the back frame 200 is performed based on the point whether the connector 300 is connected to the fastener 400 as the rotation central point.

In particular, as the cushion frame 100 rotationally moves forward and the lower end 202 of the back frame 200 is connected to the cushion frame 100 by the linkage 160 and the upper end 204 is connected to the fixed means of the vehicle body A by the connector 300, the height of the back frame 200 is changed due to the rotation of the first connection link 162 and the second connection link 164 and the connector 300 rotates in the fastener 400 and thus rotates to recline toward back of the back frame 200.

As a result, the lower end 202 of the back frame 200 moves forward while the cushion frame 100 rotationally moves forward and the upper end 204 moves backward, such that passengers can be seated in a comfortable position.

According to the apparatus for reclining a rear seat for a vehicle having the above structure, it is possible to simultaneously perform the reclining of the seat cushion and the seat back by changing the angle of the seat back which is operated together with the seat cushion as the seat cushion moves.

As a result, it is possible to provide the more comfort riding quality to the rear seat passengers.

Although the present inventive concept has been shown and described with respect to specific exemplary embodiments, it will be obvious to those skilled in the art that the present disclosure may be variously modified and altered without departing from the spirit and scope of the present inventive concept as defined by the following claims.

What is claimed is:

1. An apparatus for reclining a rear seat for a vehicle, comprising:
a cushion frame having a front end and a rear end, respectively, and rotatably mounted to a vehicle floor through a link, the cushion frame being connected to the vehicle floor via a motor driver to rotationally move forward as the motor driver operates;
a back frame having a lower end rotatably mounted to the rear end of the cushion frame, and an upper end having a connector which is connected to a vehicle body; and
a fastener fixedly mounted to the vehicle body and adjacent to the upper end of the back frame, the fastener rotatably connected to the connector.

2. The apparatus of claim 1, wherein the front end is rotatably mounted to the vehicle floor through a first link and the rear end is rotatably mounted to the vehicle floor through a second link, and
wherein the cushion frame rotationally moves forward by rotation of the first link and the second link when the motor driver operates.

3. The apparatus of claim 1, wherein the motor driver includes a driving motor mounted to the front end of the cushion frame and a lead screw extending from the driving motor toward the rear end of the cushion frame to be connected to the vehicle floor such that as the driving motor moves along the lead screw at the time of the operation of the driving motor, the cushion frame rotationally moves forward and backward.

4. The apparatus of claim 1, wherein the rear end of the cushion frame and the lower end of the back frame are connected to each other to rotate by a linkage.

5. The apparatus of claim 4, wherein the linkage includes a first connection link rotatably installed at the rear end of the cushion frame and a second connection link rotatably connected to the first connection link and having a bracket to which the back frame is connected.

6. The apparatus of claim 1, wherein the connector is a striker which extends downward from the upper end of the back frame, and the fastener is a fixed hook having a “U” shape of which an upper portion is opened and into which the connector is inserted.

7. The apparatus of claim 6, wherein the connector extends downward from the upper end of the back frame into the upper portion of the fastener at a predetermined angle with respect to the back frame to be inclined, and the connector is maintained at a right angle with respect to vehicle floor in the fastener.

8. The apparatus of claim 6, wherein the fastener has a lower end fixed to the vehicle body and a front end and a rear end extending upward from a front portion and a rear portion of the lower end of the fastener, respectively and a fastening hole is formed between the front end and the rear end.

9. The apparatus of claim 8, wherein the rear end of the fastener, which has a flat upper portion extending backward, is concavely recessed forward from a lower portion thereof and convexly protrudes backward to be connected to the lower end of the fastener.

10. The apparatus of claim 2, wherein the first link and the second link rotationally move while supporting a load of the cushion frame, and the link is foamed in plural to secure the load.

11. The apparatus of claim 5, wherein the cushion frame has a radius of rotation different from that of the back frame, and the rear end of the cushion frame has a height different from that of the lower end of the back frame when the motor driver operates such that an angle of the back frame with respect to the vehicle body smoothly varies.

12. The apparatus of claim 8, wherein the fastening hole has an upper width smaller than a width of the connector, and a lower width of the fastening hole is equal to or large than the width of the connector.

13. The apparatus of claim 1, wherein the fastener is elastically deformable.
